(19) United States
(12) Patent Application Publication
(10) Pub. No.: US 2007/0272255 A1
(43) Pub. Date: Nov. 29, 2007

(54) Device and method for preventing shoulder dystocia

(76) Inventor: Syed Rizvi, Hemet, CA (US)

Correspondence Address: Syed Rizvi, 200 North Yale Street #112, Hemet, CA, 92544, US

(21) Appl. No.: 11/805,365

(22) Filed: May 23, 2007

Related U.S. Application Data
(60) Provisional application No. 60/802,819, filed on May 24, 2006.

(51) Int. Cl. A61G 15/00

(52) U.S. Cl. 128/845

(57) ABSTRACT

The present invention relates to devices and methods that are used by a parturient during labor. More particularly, the present invention relates to devices and methods for preventing and managing shoulder dystocia. The present invention further relates to devices and methods for assisting a parturient with laboring efforts. In a first preferred embodiment of the invention, such methods comprise (a) providing a parturient with a first and second device, wherein each device comprises two loops joined together to form a middle portion, (b) inserting the parturient's left foot into a first loop of the first device such that the first loop of the first device rests against a plantar surface of said left foot, (c) inserting the parturient's right foot into a first loop of the second device such that the first loop of the second device rests against a plantar surface of said right foot, (d) inserting the parturient's left hand through a second loop of the first device, wherein the second loop of the first device rests against a dorsal surface of the parturient's left wrist, wherein the parturient further grasps and holds the middle portion of the first device with said left hand, (e) inserting the parturient's right hand through a second loop of the second device, wherein the second loop of the second device rests against a dorsal surface of the parturient's right wrist, wherein the parturient further grasps and holds the middle portion of the second device with said right hand, and (f) having the parturient pull both the first and second device backwards to simultaneously perform hip flexion and feet abduction during labor.

### CROSS-REFERENCE TO RELATED APPLICATIONS

This application claims priority to, and incorporates by reference, U.S. provisional patent application Ser. No. 60/802,819, filed May 24, 2006.

### FIELD OF THE INVENTION

The present invention relates to the field of devices and methods that may be used by a parturient during labor. More particularly, the present invention relates to devices and methods for preventing, managing, and mitigating the effects of shoulder dystocia. The present invention further relates to devices and methods for assisting a parturient with laboring efforts and reducing various obstetrical complications.

### BACKGROUND OF THE INVENTION

Shoulder dystocia is an obstetric emergency that is generally defined as the failure of the fetal shoulders to deliver, despite routine obstetric maneuvers, after the fetal head has been delivered. Shoulder dystocia can lead to serious injury of the infant and mother. Potential fetal complications include death, permanent neurologic impairment, brachial plexus injury, fractures of the clavicle and humerus, and Erb's palsy resulting in permanent disability, while the mother may suffer vaginal and cervical lacerations, significant blood loss, or uterine rupture. Additional maternal trauma during shoulder dystocia includes bladder injury, hematoma, spontaneous separation of the symphysis pubis, postpartum hemorrhage, and endometritis.

Hyperflexion of the mother's hips, which is also known as the McRoberts Maneuver, is generally considered to be the safest and most successful technique for relieving shoulder dystocia. There have been no reported adverse maternal outcomes associated with this technique. It has also been found that performing feet abduction and hip flexion increases the effectiveness of the procedure, and also prevents a patient's feet from obstructing the delivery. Typically, two nurses are required to perform the McRoberts Maneuver. One nurse stands on each side of the mother and holds, supports and pushes against the plantar surface of the mother's foot to flex the hip. When this maneuver is successful, the fetus is delivered with normal traction.

There are many known mechanical benefits of the McRoberts Maneuver, including elevation of the anterior fetal shoulder, flexion of fetal spine, pushing of the posterior fetal shoulder over the sacrum, straightening of the maternal lordosis, removal of the sacral promontory as the point of obstruction, removal of weight-bearing force from the sacrum, opening of the pelvic inlet to maximum, bringing the pelvic inlet perpendicular to maximum expulsive force, conversion of voluntary maternal expulsive effort into enhanced intrauterine pressure, increased intrauterine pressure during the second stage of labor, and increased amplitude of uterine contractions.

While the involvement of multiple nurses to carry out the McRoberts Maneuver during a delivery has been shown to effectively mitigate the effects of shoulder dystocia, there has been and continues to be a demand for devices and methods that may be used to carry out or simulate the McRoberts Maneuver during labor. More specifically, in view of the rising costs of healthcare, and particularly the cost of having multiple nurses present to perform techniques such as the McRoberts Maneuver, there has been and continues to be a demand for devices and methods that may be operated by a parturient (without the assistance of nursing personnel) to carry out or simulate the McRoberts Maneuver during labor. In addition, such devices and methods that may be operated by a parturient (without the assistance of nursing personnel) could be used to deliver an infant at home, such as with the assistance of a midwife.

Numerous birthing aids have been described and developed over the years. Such birthing aids, however, were not designed or capable of being effectively used for the prevention and the treatment of shoulder dystocia. In fact, many of such prior birthing aids should be avoided, insofar as they employ bands and other materials that compress the parturient's thighs and shins (and, therefore, the nerves and blood vessels located in the parturient's thighs and shins). Prolonged compression of the nerves and blood vessels located in the parturient's thighs and shins has been correlated with neuropathy and thromboembolism. The risk of thrombbembolic complications is increased by pregnancy itself due to hypercoagulability. Thus, prolonged compression of the nerves and blood vessels by medical devices consisting of bands or other materials pressed against a parturient's thighs and/or shins may lead to thromboembolism, compression neuropathy and even death.

Accordingly, there has been and continues to be a demand for devices and methods that may be operated by a parturient (without the assistance of nursing personnel) to carry out or simulate the McRoberts Maneuver during labor, whereby the risk of compression neuropathy and thromboembolic complications is reduced. Still further, such devices and methods will preferably reduce the amount of elbow flexion and shoulder extension required of the parturient, which can lead to maternal exhaustion. More particularly, it is preferred that such devices and methods avoid the considerable elbow flexion and shoulder extension that are often required of various prior art devices, which often require the parturient to pull on bands or other material placed around the parturient's knees. As described further below, the present invention addresses many of the foregoing needs and demands for such devices and methods.

### SUMMARY OF THE INVENTION

According to a first preferred embodiment of the present invention, devices are provided for (i) preventing, treating, or mitigating the effects of shoulder dystocia, (ii) reducing obstetrical complications, (iii) facilitating labor efforts, and (iv) the other methods described herein. Such devices generally comprise a contiguous piece of material, which is preferably a flexible material, such as but not limited to a webbing textile material. The devices are adapted to comprise two loops, wherein each loop ranges in length from approximately 5 to 9 inches when lying flat. In addition, such devices comprise a middle portion located between the two loops, wherein the middle portion ranges in length from approximately 1 to 3 inches. The middle portion of such devices may be formed by attaching both ends of a linear piece of webbing textile material to a central location of the same linear piece of webbing textile material using an attachment means, thereby forming the middle portion and two loops. Alternatively, the middle portion of such devices may be formed by joining two portions of a circular piece of webbing textile material together using an attachment means, thereby forming the middle portion and two loops. The foregoing design and construction of such devices has been shown to be particularly well-suited for the methods described herein. Moreover, such design and construction allows the devices to be manufactured in an efficient and affordable manner.

According to another preferred embodiment of the present invention, methods for preventing, treating, or mitigating the effects of shoulder dystocia are provided. More particularly, such methods comprise (a) providing a parturient with a first and second device, wherein each device comprises two loops joined together to form a middle portion, (b) inserting the parturient's left foot into a first loop of the first device such that the first loop of the first device rests against the plantar surface of such left foot, (c) inserting the parturient's right foot into a first loop of the second device such that the first loop of the second device rests against the plantar surface of such right foot, (d) inserting the parturient's left hand through a second loop of the first device, wherein the second loop of the first device rests against the dorsal surface of the parturient's left wrist, wherein the parturient may optionally grasp and hold the middle portion of the first device with her left hand, (e) inserting the parturient's right hand through a second loop of the second device, wherein the second loop of the second device rests against the dorsal surface of the parturient's right wrist, wherein the parturient may optionally grasp and hold the middle portion of the second device with her right hand, and (f) having the parturient pull both the first and second device backwards to simultaneously perform hip flexion and feet abduction during labor.

According to another preferred embodiment of the present invention, methods for (1) reducing obstetrical complications, (2) reducing the risk of compression neuropathy, (3) reducing the risk of thromboembolism, (4) providing a self-restraining means to a parturient, (5) assisting a parturient with laboring efforts, (6) enabling a parturient to maximize laboring efforts, (7) enabling a parturient to simultaneously perform hip flexion and feet abduction during labor (and, optionally, without the assistance of medical personnel), (8) enabling a parturient to convert voluntary maternal. expulsive efforts into enhanced intrauterine pressure, (9) increasing intrauterine pressure and contraction amplitude during the second stage of labor, (10) reducing the number of medical personnel required during labor and delivery, and (11) improving patient compliance and restricting undesired activities of a parturient during labor are provided. The foregoing methods generally comprise (a) providing a parturient with a first and second device, wherein each device comprises two loops joined together to form a middle portion,. (b) inserting the parturient's left foot into a first loop of the first device such that the first loop of the first device rests against the plantar surface of such left foot, (c) inserting the parturient's right foot into a first loop of the second device such that the first loop of the second device rests against the plantar surface of such right foot, (d) inserting the parturient's left hand through a second loop of the first device, wherein the second loop of the first device rests against the dorsal surface of the parturient's left wrist, wherein the parturient may optionally grasp and hold the middle portion of the first device with her left hand, (e) inserting the parturient's right hand through a second loop of the second device, wherein the second loop of the second device rests against the dorsal surface of the parturient's right wrist, wherein the parturient may optionally grasp and hold the middle portion of the second device with her right hand, and (f) having the parturient pull both the first and second device backwards to simultaneously perform hip flexion and feet abduction during labor.

The foregoing methods may be carried out by the parturient without the assistance of nursing staff or a physician. The first and second device may be used independently by a parturient, either in presence of medical personnel or during a natural delivery in a home environment. For example, the first and second device may be used by a parturient herself, pursuant to the instruction of a healthcare professional, such as an obstetrician or nurse, thereby allowing such healthcare professionals to attend to other procedures during the delivery.

### BRIEF DESCRIPTION OF THE DRAWINGS

The above and other features and advantages of the present invention will become more apparent from the following description of the present invention taken in conjunction with the accompanying drawings, in which:

FIG. 1 is a top view of a laboring device of the present invention.

FIG. 2 is a top view of a laboring device of the present invention that is lying flat.

FIG. 3 is a side view of a parturient using the device of the present invention, whereby the parturient is grasping the middle portion thereof.

FIG. 4 is a side view of a parturient using the device of the present invention, whereby the parturient is grasping a loop portion thereof.

FIG. 5 is a front view of a parturient using the device of the present invention.

FIG. 6 is a front view of a parturient using the device of the present invention, while the fetal head is delivered.

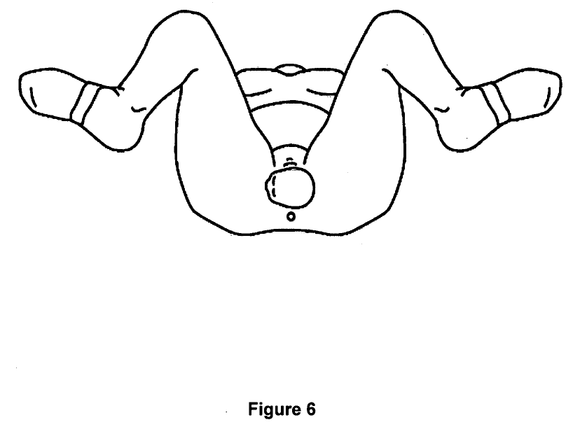

### DETAIL DESCRIPTION OF THE INVENTION

The present invention relates to devices and methods that are used by a parturient during labor. More particularly, the present invention relates to devices and methods for preventing, managing, and mitigating the effects of shoulder dystocia. The present invention further relates to devices and methods for assisting a parturient with laboring efforts and a plurality of other obstetrical methods described below. As used herein, the term “parturient” refers to a human being who is in labor and is engaged in the process of delivering a fetus.

According to certain preferred embodiments of the present invention, devices are provided for preventing, treating and mitigating the effects of shoulder dystocia, reducing obstetrical complications during labor, facilitating a parturient's labor efforts, and the other obstetrical-related methods described herein. Such devices generally comprise a contiguous piece of material, which is preferably a flexible material, such as but not limited to flexible textiles, leather, composites, plastics, elastomers, rubbers, nylon, polymers (such as polypropylene), webbing textile materials, and combinations thereof.

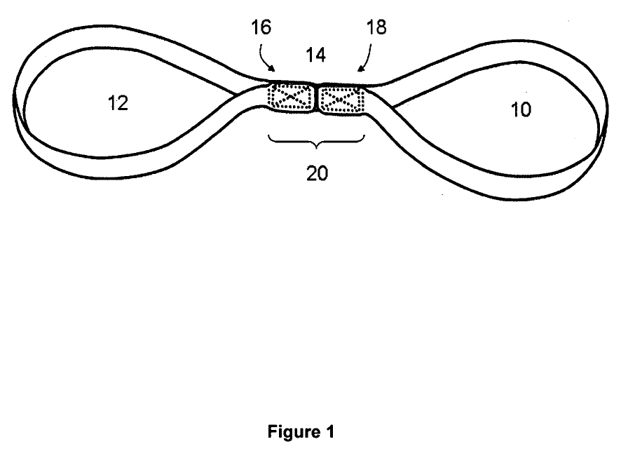

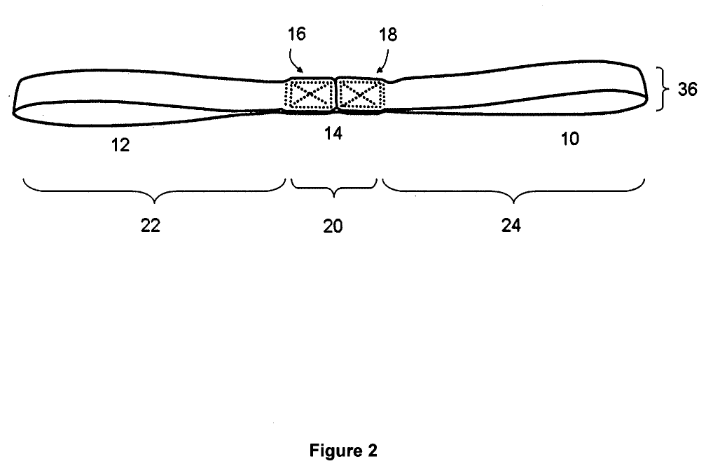

Referring to FIG. 1, the devices of the present invention are adapted to comprise two loops 10,12. The loops may be substantially symmetrical to one another, or may vary in dimensions. Referring to FIG. 2, in certain preferred embodiments of the invention, the length of each loop 22,24 is approximately 5 to 9 inches when lying flat. In certain preferred embodiments of the invention, the loops 10,12 are substantially symmetrical to one another, and each loop is approximately 7 inches long 22,24 when lying flat, as shown in FIG. 2.

In addition, the devices of the present invention comprise a middle portion 14 located between the two loops 10,12. The middle portion may be configured to exhibit a range of different lengths 20, but preferably ranges from approximately 1 to 3 inches in length. In certain preferred embodiments, the middle portion 14 is approximately 2 inches in length 20. The width 36 of the devices of the present invention may also vary. Preferably, the width 36 of the devices will be approximately 0.5 to 2 inches and, more preferably, about 1 inch.

The middle portion 14 of such devices may be formed by attaching both ends of a linear piece of material, such as a webbing textile material, to a central location of the same linear piece of webbing textile material using an attachment means, thereby forming the middle portion 14 and two loops 10,12. Alternatively, the middle portion 14 of such devices may be formed by joining two portions of a circular and closed piece of material together, such as webbing textile material, using an attachment means, thereby forming the middle portion 14 and two loops 10,12. For example, in such alternative embodiments, the opposing midpoints of a circular and closed piece of material may be joined together using an attachment means. Non-limiting examples of such attachment means include stitching, adhesives, staples, clipping, knotting, and welding. In certain preferred embodiments, the attachments means consists of stitches, whereby, for example, both ends of a linear piece of material may be stitched to a central location 16,18 of the same linear piece of material to form a device having two loops 10,12 and a middle portion 14.

It is well-known that certain materials, such as composites, various polymers, and other compositions, melt in the presence of heat and will solidify (or cure) when such heat is removed. The invention also contemplates that the device may consist of, or its middle portion 14 may be provided with, such composites and/or polymers, such that the middle portion 14 may be formed by applying heat thereto, such that (i) both ends of a linear piece of material may be “welded” to a central location of the same linear piece of material or (ii) two portions of a circular and closed piece of material may be “welded” together, thereby forming a device having two loops 10,12 and a middle portion 14.

The foregoing design and construction of such devices has been shown to be particularly well-suited for the methods described herein, namely, for preventing, treating and mitigating the effects of shoulder dystocia, reducing obstetrical complications during labor, facilitating a parturient's labor efforts, and the other obstetrical-related methods described herein. In particular, the invention provides that a device of the present invention having two loops 10,12 of approximately 7 inches in length 22,24 when lying flat (each loop 22,24 having a circumference of about 14 inches), and a middle portion 14 of approximately 2 inches in length 20, has been shown to be particularly well-suited and tailored for use by a parturient in the methods described herein. Indeed, such dimensions have been shown to produce a device that comprises two loops 10,12 and a middle portion 14 that is accommodating to the average parturient, taking into account (i) the average parturient's height, arm length, leg length, hand size, and other bodily dimensions and (ii) the desire to reduce the amount of elbow flexion and shoulder extension required of the parturient during use of the device (which can otherwise lead to maternal exhaustion).

Moreover, it has been found that such devices may be manufactured in an extremely efficient and affordable manner. A significant advantage of the devices of the present invention is that the devices may be manufactured from readily available materials (such as flexible webbing textile materials) and, more importantly, may be constructed from a single contiguous piece of material. The only significant manufacturing step is attaching one or more portions of such material to itself, in order to form the two loops 10,12 and middle portion 14. Many of the prior art birthing aids require the construction of cumbersome and elaborate back supports (or, even worse, shin and thigh braces that exert pressure on the parturient's nerves and blood vessels), which the devices of the present invention do not require and avoid.

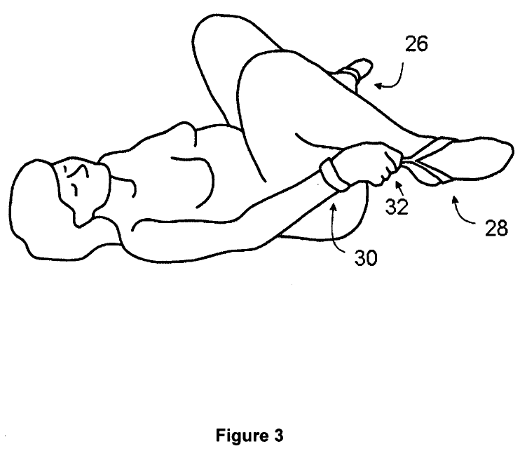

According to another preferred embodiment of the present invention, methods for preventing, treating and mitigating the effects of shoulder dystocia are provided. Shoulder dystocia is an obstetric emergency that is generally defined as failure of the fetal shoulders to deliver, despite routine obstetric maneuvers, after the fetal head has been delivered. Referring to FIG. 3, for example, the methods of the present invention generally comprise (a) providing a parturient with a first and second device of the present invention, wherein each device comprises two loops 10,12 joined together to form a middle portion 14, (b) inserting the parturient's left foot into a first loop of the first device such that the first loop of the first device rests against the plantar surface of such left foot 26, (c) inserting the parturient's right foot into a first loop of the second device such that the first loop of the second device rests against the plantar surface of such right foot 28, (d) inserting the parturient's left hand through a second loop of the first device, wherein the second loop of the first device rests against the dorsal surface of the parturient's left wrist, wherein the parturient may optionally grasp and hold the middle portion of the first device with her left hand, (e) inserting the parturient's right hand through a second loop of the second device, wherein the second loop of the second device rests against the dorsal surface of the parturient's right wrist 30, wherein the parturient may optionally grasp and hold the middle portion of the second device with her right hand 32, and (f) having the parturient pull both the first and second device backwards to simultaneously perform hip flexion and feet abduction during labor.

In referring to the devices of the present invention resting against the dorsal surface of a parturient's wrist 30 (as shown in FIG. 3), it should be understood that “wrist” may refer to not only the parturient's actual wrist, but also the dorsal surface immediately adjacent to the parturient's wrist, such as the dorsal surface of the parturient's hand or lower arm portion. That is, it should be appreciated that the device may also rest against the dorsal surface of a parturient's hand or lower arm portion, depending on the bodily dimensions of the parturient (and which orientation is most comfortable to the parturient).

According to additional embodiments of the present invention, methods for (1) reducing obstetrical complications, (2) reducing the risk of compression neuropathy, (3) reducing the risk of thromboembolism, (4) providing a self-restraining means to a parturient, (5) assisting a parturient with laboring efforts, (6) enabling a parturient to maximize laboring efforts, (7) enabling a parturient to simultaneously perform hip flexion and feet abduction during labor (and, optionally, without the assistance of medical personnel), (8) enabling a parturient to convert voluntary maternal expulsive efforts into enhanced intrauterine pressure, (9) increasing intrauterine pressure and contraction amplitude during the second stage of labor, (10) reducing the number of medical personnel required during labor and delivery, and (11) improving patient compliance and restricting undesired activities of a parturient during labor are provided. Similar to the other embodiments described above, such methods generally comprise (a) providing a parturient with a first and second device of the present invention, wherein each device comprises two loops 10,12 joined together to form a middle portion 14, (b) inserting the parturient's left foot into a first loop of the first device such that the first loop of the first device rests against the plantar surface of such left foot 26, (c) inserting the parturient's right foot into a first loop of the second device such that the first loop of the second device rests against the plantar surface of such right foot 28, (d) inserting the parturient's left hand through a second loop of the first device, wherein the second loop of the first device rests against the dorsal surface of the parturient's left wrist, wherein the parturient may optionally grasp and hold the middle portion of the first device with her left hand, (e) inserting the parturient's right hand through a second loop of the second device, wherein the second loop of the second device rests against the dorsal surface of the parturient's right wrist 30, wherein the parturient may optionally grasp and hold the middle portion of the second device with her right hand 32, and (f) having the parturient pull both the first and second device backwards to simultaneously perform hip flexion and feet abduction during labor.

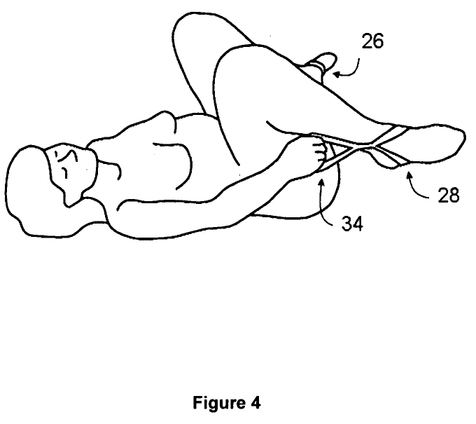

In some cases, the dorsal side of a parturient's wrist may not be accessible or capable of being used in the methods described herein. For example, an intravenous access site located on the dorsal side of a parturient's wrist may render such location inaccessible. In such cases, and referring to FIG. 4, the invention provides that the parturient may grasp, hold, and pull back on the loops 34, instead of the middle portion 14.

The foregoing methods may be carried out by the parturient without the assistance of nursing staff or a physician. The first and second device may be used independently by a parturient, either in presence of medical personnel or during a natural delivery in a home environment. For example, the first and second device may be used by a parturient (pursuant to the instruction and in the presence of a healthcare professional, such as an obstetrician or nurse), thereby allowing such healthcare professionals to attend to other procedures during the delivery (versus being constrained to, for example, performing the McRoberts Maneuver on the parturient).

Those of ordinary skill in the art will appreciate that while the description of the devices and methods herein refer to, for example, “providing a parturient with a first and second device,” “inserting the parturient's left foot into a first loop of the first device,” “inserting the parturient's left hand through a second loop of the first device,” and similar terms and phrases, it should be understood that such actions may be carried out (a) by medical personnel in assisting the parturient to properly engage and use the device of the present invention, (b) by the parturient in accordance with the instruction (and/or with the assistance of) medical personnel or (c) entirely on the parturient's own will. That is, terms and phrases such as “providing a parturient with a first and second device,” “inserting the parturient's left foot into a first loop of the first device,” “inserting the parturient's left hand through a second loop of the first device,” and similar phrases used herein should not be construed to mean that such actions must be carried out by medical personnel (or other persons) in conjunction with the parturient, but rather such terms and phrases should be construed to mean that such actions may be carried out (a) by medical personnel in assisting the parturient to properly engage and use the device of the present invention, (b) by the parturient herself in accordance with the instruction (and/or with the assistance of) medical personnel or (c) by the parturient herself—entirely on her own will and without any assistance.

The methods of the present invention have been shown to provide many significant advantages over the more cumbersome, and even dangerous, birthing aids in the prior art. Notably, the device and methods of the present invention are particularly adapted to prevent, treat and mitigate the effects of shoulder dystocia, which is an obstetrical complication for which few, if any, currently-available medical devices address. In addition, the devices and methods of the present invention enable a parturient to perform (or emulate) the McRoberts Maneuver, without the direct involvement of medical personnel. This serves to allow such personnel to perform other functions or to reduce the number of nurses, for example, required to be present during a delivery, thereby providing a significant economic benefit to a healthcare facility.

In addition, because the parturient is operating the device herself, it allows the parturient to experience instant feedback from her efforts in pulling back on the device during a delivery. The autonomous nature of the parturient's usage of such device and methods further enhances patient compliance (by restricting other undesired activities during the second stage of labor) and allows the patient to be more closely involved and have more control over in the delivery process.

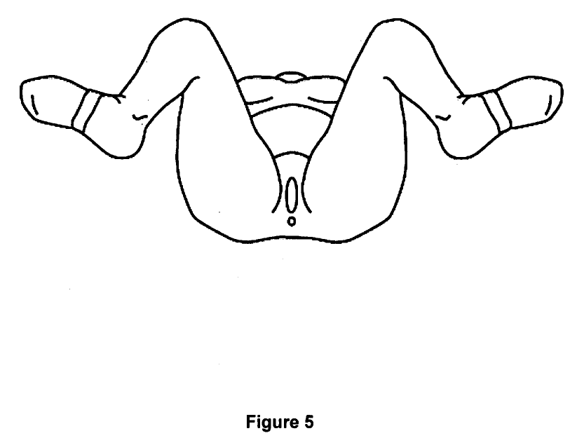

Still further, the devices (and methods of use thereof exploit the durability of the plantar surface of a person's foot. As shown in FIG. 5 and described above, a first loop of the devices of the present invention are pressed against the plantar surface of the parturient's feet. It is well-known that such plantar surfaces are capable of withstanding repetitive and prolonged stresses. The design and use of the devices of the present invention take advantage of this characteristic, thereby providing a safe and effective means for simultaneously performing hip flexion and feet abduction during labor. Moreover, the design and use of the devices of the present invention avoids compressing or exerting pressure on the parturient's shins and thighs and, therefore, reduces the risk of compression neuropathy and thromboembolism.

Although the foregoing invention has been described in detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims. In the claims, elements and/or steps do not imply any particular order of operation, unless explicitly stated in the claims (or the context otherwise requires a particular order of operation).

What is claimed is:

1. A method of preventing or mitigating the effects of shoulder dystocia, which comprises:
(a) providing a parturient with a first and second device, wherein each device comprises two loops joined together to form a middle portion;
(b) inserting the parturient's left foot into a first loop of the first device such that the first loop of the first device rests against a plantar surface of said left foot;
(c) inserting the parturient's right foot into a first loop of the second device such that the first loop of the second device rests against a plantar surface of said right foot;
(d) inserting the parturient's left hand through a second loop of the first device, wherein the second loop of the first device rests against a dorsal surface of the parturient's left wrist, wherein the parturient further grasps and holds said middle portion of the first device with said left hand;
(e) inserting the parturient's right hand through a second loop of the second device, wherein the second loop of the second device rests against a dorsal surface of the parturient's right wrist, wherein the parturient further grasps and holds said middle portion of the second device with said right hand; and
(f) having the parturient pull both the first and second device backwards to simultaneously perform hip flexion and feet abduction during labor.

2. The method of claim 1, wherein the device is comprised of a webbing textile material.

3. The method of claim 2, wherein the device consists of a contiguous piece of webbing textile material, wherein the middle portion is formed by:
(a) attaching both ends of a linear piece of webbing textile material to a central location of the same linear piece of webbing textile material using an attachment means, thereby forming the middle portion and two loops; or
(b) joining two portions of a circular piece of webbing textile material together using an attachment means, thereby forming the middle portion and two loops.

4. The method of claim 3, wherein the attachment means is selected from the group consisting of stitching, adhesives, staples, clipping, knotting, and welding.

5. The method of claim 4, wherein (a) the middle portion ranges in length from approximately 1 to 3 inches, (b) each loop of the device ranges in length, when lying flat, from approximately 5 to 9 inches, and (c) the device is approximately 0.5 to 2 inches in width.

6. The method of claim 5, wherein the middle portion is approximately 2 inches in length.

7. The method of claim 5, wherein each loop of the device is approximately 7 inches in length when lying flat.

8. The method of claim 5, wherein the device is approximately 1 inch in width.

9. A method of preventing or mitigating the effects of shoulder dystocia, which comprises:
(a) providing a parturient with a first and second device, wherein each device consists of a contiguous linear piece of webbing textile material, wherein both ends thereof are permanently stitched to a central location of the same linear piece of webbing textile material to form a middle portion and two loops, wherein the middle portion is approximately 2 inches in length and each loop is approximately 7 inches in length when lying flat;
(b) inserting the parturient's left foot into a first loop of the first device such that the first loop of the first device rests against a plantar surface of said left foot;
(c) inserting the parturient's right foot into a first loop of the second device such that the first loop of the second device rests against a plantar surface of said right foot;
(d) inserting the parturient's left hand through a second loop of the first device, wherein the second loop of the first device rests against a dorsal surface of the parturient's left wrist, wherein the parturient further grasps and holds said middle portion of the first device with said left hand;
(e) inserting the parturient's right hand through a second loop of the second device, wherein the second loop of the second device rests against a dorsal surface of the parturient's right wrist, wherein the parturient further grasps and holds said middle portion of the second device with said right hand; and
(f) having the parturient pull both the first and second device backwards to simultaneously perform hip flexion and feet abduction during labor.

10. A method of reducing obstetrical complications, the risk of compression neuropathy and the risk of thromboembolism during labor, wherein the method comprises:
(a) providing a parturient with a first and second device, wherein each device comprises two loops joined together to form a middle portion;
(b) inserting the parturient's left foot into a first loop of the first device such that the first loop of the first device rests against a plantar surface of said left foot;
(c) inserting the parturient's right foot into a first loop of the second device such that the first loop of the second device rests against a plantar surface of said right foot;
(d) inserting the parturient's left hand through a second loop of the first device, wherein the second loop of the first device rests against a dorsal surface of the parturient's left wrist, wherein the parturient further grasps and holds said middle portion of the first device with said left hand;
(e) inserting the parturient's right hand through a second loop of the second device, wherein the second loop of the second device rests against a dorsal surface of the parturient's right wrist, wherein the parturient further grasps and holds said middle portion of the second device with said right hand; and
(f) having the parturient pull both the first and second device backwards to simultaneously perform hip flexion and feet abduction during labor.

11. The method of claim 10, wherein the device is comprised of a webbing textile material.

12. The method of claim 11, wherein the device consists of a contiguous piece of webbing textile material, wherein the middle portion is formed by:
(a) attaching both ends of a linear piece of webbing textile material to a central location of the same linear piece of webbing textile material using an attachment means, thereby forming the middle portion and two loops; or
(b) joining two portions of a circular piece of webbing textile material together using an attachment means, thereby forming the middle portion and two loops.

13. The method of claim 12, wherein the attachment means is selected from the group consisting of stitching, adhesives, staples, clipping, knotting, and welding.

14. The method of claim 13, wherein (a) the middle portion ranges in length from approximately 1 to 3 inches, (b) each loop of the device ranges in length, when lying flat, from approximately 5 to 9 inches, and (c) the device is approximately 0.5 to 2 inches in width.

15. The method of claim 14, wherein the middle portion is approximately 2 inches in length.

16. The method of claim 14, wherein each loop of the device is approximately 7 inches in length when lying flat.

17. The method of claim 14, wherein the device is approximately 1 inch in width.

18. A device for preventing or mitigating the effects of shoulder dystocia, which comprises a contiguous piece of material, wherein the material is adapted to comprise:
(a) two loops, wherein each loop is approximately 5 to 9 inches in length when lying flat; and
(b) a middle portion located between said loops, wherein the middle portion is approximately 1 to 3 inches in length.

19. The device of claim 18, wherein the material is comprised of a webbing textile material.

20. The device of claim 19, wherein the middle portion is formed by:
(a) attaching both ends of a linear piece of webbing textile material to a central location of the same linear piece of webbing textile material using an attachment means, thereby forming the middle portion and two loops; or
(b) joining two portions of a circular piece of webbing textile material together using an attachment means, thereby forming the middle portion and two loops.

21. The device of claim 20, wherein the attachment means is selected from the group consisting of stitching, adhesives, staples, clipping, knotting, and welding.
